(19) United States
(12) Patent Application Publication
(10) Pub. No.: US 2005/0212900 A1
(43) Pub. Date: Sep. 29, 2005

(54) Multibeam exposure method and device

(75) Inventors: Takao Ozaki, Kanagawa (JP); Teppei Ejiri, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/091,510

(22) Filed: Mar. 29, 2005

(30) Foreign Application Priority Data
Mar. 29, 2004 (JP) 2004-96751
Mar. 11, 2005 (JP) 2005-69781

(51) Int. Cl. B41J 2/435; B41J 2/47

(52) U.S. Cl. 347/237

(57) ABSTRACT

A multibeam exposure method and device are provided. Scan-exposure is carried out in a state in which positions of exposure beam spots, which are projected onto an exposure surface from a section which selectively turns pixels on and off, are divided into blocks, and relative positions between the blocks are shifted by a predetermined amount, and gaps, in a feeding direction, at positions of exposure beam spots exposed at one block, are exposed by plural exposure beam spots at another block.

### CROSS-REFERENCE TO RELATED APPLICATION

This application claims priority under 35 USC 119 from Japanese Patent Application Nos. 2004-096751 and 2005-69781, the disclosure of which is incorporated by reference herein.

### BACKGROUND OF THE INVENTION

1. Field of the Invention

The present invention relates to an exposure method and device by multibeams which can improve addressability in a main scanning direction (a direction of relative movement between an exposure head and a photosensitive material) at the time when exposure is carried out in a predetermined pattern by collecting and irradiating, on a pixel-by-pixel basis and from an optical element such as a lens array or the like, beams which exit from a means which, on the basis of image data (pattern data), selectively turns on and off a plurality of pixels of a spatial light modulator or the like disposed at the exposure bead.

2. Description of the Related Art

In recent years, development has advanced of multibeam exposure devices which use spatial light modulators called digital micromirror devices (DMDs), or the like, as pattern generators, and which carry out image exposure on a member-to-be-exposed, by a light beam modulated in accordance with image data.

A DMD is a mirror device in which, for example, a large number of micromirrors, at which the angles of the reflecting surfaces thereof are varied in accordance with control signals, are lined-up in two dimensions on a semiconductor substrate of silicon or the like. The angles of the reflecting surfaces of the micromirrors are varied by electrostatic forces due to electric charges accumulated in respective memory cells.

A multibeam exposure device using such a DMD uses an exposure head in which, for example, laser beams exiting from a light source which emits the laser beams are collimated by a lens system, the respective laser beams are reflected by the plural micromirrors of a DMD disposed substantially at the focal point position of the lens system, and the respective beams exit from plural beam exit openings. High-resolution image exposure is carried out by forming an image, by making the spot diameters small, on an exposure surface of a photosensitive material (a member-to-be-exposed) by a lens system having an optical element such as a microlens array or the like which collects, at a single lens and for each one pixel, each beam exiting from the beam exit opening of the exposure head.

In such an exposure device, the respective micromirrors of the DMD are controlled on and off by an unillustrated control device on the basis of control signals generated in accordance with image data or the like, and the laser beams are modulated (deflected), and the modulated laser beams are irradiated onto the exposure surface (recording surface) such that exposure is carried out.

A photosensitive material (a photoresist or the like) is disposed at the recording surface. The exposure device is structured so as to be able to carry out processing for exposing a pattern on the photosensitive material, by modulating respective DMDs in accordance with image data, while relatively moving, with respect to the photosensitive material, the positions of the beam spots where the laser beams are irradiated and form images on the photosensitive material from plural exposure heads of the multibeam exposure device.

Conventionally, a DMD used in such an exposure device is structured such that m rows are lined up in the scanning direction, and n columns are lined up in the direction orthogonal to the scanning direction. By disposing the rows of pixels to be inclined at a predetermined angle with respect to the scanning direction of the exposure head and carrying out multiple exposure N times in the scanning direction, the DMD can form m/N-1 dots between the scan lines. Changing the dot pitch and improving the addressability in the scanning direction and in the direction orthogonal to the scanning direction, by adjusting the number of times of multiple exposure in the scanning direction in this way, has been proposed (see, for example, Japanese Patent Application Laid-Open (JP-A) No. 2004-012899).

In such an exposure device, the feed addressability with respect to the main scanning direction (the direction of relative movement between the exposure head and the photosensitive material) is determined by the modulation period of modulating all of the micromirrors of the DMD in accordance with the image data (the intervals between the exposure times), and the feeding speed in the main scanning direction (the relative moving speed between the exposure head and the photosensitive material).

Thus, when high feed addressability is required in an exposure device for use in, for example, the processing of exposing a circuit pattern onto a substrate with high accuracy, because there are limits to shortening the modulation period for driving the DMD, the feeding speed (the relative moving speed between the exposure head and the photosensitive material) in the main scanning direction (the feeding direction) must be reduced, and the processing efficiency of the exposure device deteriorates.

### SUMMARY OF THE INVENTION

In view of the aforementioned, a multibeam exposure method and device is in need, which can improve feed addressability and carry out exposure processing with high accuracy, without reducing the relative feeding speed between a photosensitive material and an exposure head provided with a means for selectively turning a plurality of pixels on and off.

An aspect of the present invention is a multibeam exposure device. The device is structured with an on/off element, a feed addressability improving element and a control element. The on/off element selectively turns on and off a plurality of pixels which are lined up in a scanning direction. The feed addressability improving element divides positions, on an exposure surface, of a plurality of exposure beam spots which are projected onto the exposure surface from the on/off element, into a plurality of blocks in a feeding direction, and shifting relative positions between the blocks by a predetermined amount. The control element controls the on/off element such that all of the pixels are synchronized.

Another aspect of the present invention is a multibeam exposure device. The device is structured with an on/off element selectively turning on and off a plurality of pixels which are lined up in a scanning direction, wherein the on/off element is structured so as to divide the pixels, which the on/off element selectively turns on and off, into a plurality of blocks in a feeding direction and to shift relative positions between the blocks by a predetermined amount, and a control element controls the on/off element such that all of the pixels are synchronized.

Yet another aspect of the present invention is a multibeam exposure method. The method includes dividing, into a plurality of blocks in a feeding direction, positions, on an exposure surface, of a plurality of exposure beam spots which are projected onto the exposure surface from an on/off element which selectively turns on and off a plurality of pixels which are lined up in a scanning direction; shifting relative positions between the blocks by a predetermined amount; and carrying out scan-exposure with all of the pixels synchronized.

Still yet another aspect of the present invention is a multibeam exposure method. The method includes dividing, into a plurality of blocks in a feeding direction, positions, on an exposure surface, of a plurality of exposure beam spots which are projected onto the exposure surface by an intermediate image forming section corresponding to an on/off element which selectively turns on and off a plurality of pixels which are lined up in a scanning direction; shifting relative positions between the blocks by a predetermined amount; and carrying out scan-exposure with all of the pixels synchronized.

A fifth aspect of the present invention is a method of exposing multibeams by a section which selectively turns on/off a plurality of pixels which are lined-up in a scanning direction. The method includes dividing, into a plurality of blocks and with respect to a feeding direction, positions, on an exposure surface, of a plurality of exposure beam spots which are projected onto the exposure surface from the section which selectively turns on/off the plurality of pixels, and shifting relative positions between the blocks by a predetermined amount, and carrying out scan-exposure.

A sixth aspect of the present invention is a method of exposing multibeams by an optical system having an intermediate image forming section which corresponds to a section which selectively turns on/off a plurality of pixels which are lined-up in a scanning direction. The method comprises dividing, into a plurality of blocks and with respect to a feeding direction, positions, on an exposure surface, of a plurality of exposure beam spots which are projected onto the exposure surface by the intermediate image forming section, and shifting relative positions between the blocks by a predetermined amount, and carrying out scan-exposure.

In accordance with the above-described multibeam exposure methods, gaps in the feeding direction at a plurality of exposure beam spots, which are projected onto the exposure surface from the section which selectively turns a plurality of pixels on/off and which are exposed at one block, are exposed by a plurality of exposure beam spots at another block. In this way, without lowering the relative feeding speed between the photosensitive material and the section which selectively turns the plurality of pixels on/off, the feed addressability can be improved and highly accurate exposure processing can be carried out.

A seventh aspect of the present invention is multibeam exposure device having a section which selectively turns on/off a plurality of pixels which are lined-up in a scanning direction. The device comprises: a feed addressability improving device which divides, into a plurality of blocks with respect to a feeding direction, positions, on an exposure surface, of a plurality of exposure beam spots which are projected onto the exposure surface from the section which selectively turns on/off the plurality of pixels, and shifts relative positions between the blocks by a predetermined amount.

In accordance with the above-described structure, by the feed addressability improving device, the positions of the plurality of exposure beam spots, which are projected onto the exposure surface from the section which selectively turns the plurality of pixels on/off, are divided into a plurality of blocks on the exposure surface with respect to the feeding direction, and the relative positions between the blocks are shifted by a predetermined amount. The gap positions in the feeding direction at the positions of the plurality of exposure beam spots exposed at one block, are exposed by the plurality of exposure beam spots at another block. In this way, without lowering the relative feeding speed between the photosensitive material and the section which selectively turns the plurality of pixels on/off, the feed addressability can be improved and highly accurate exposure processing can be carried out.

An eighth aspect of the present invention is a multibeam exposure device having a section which selectively turns on/off a plurality of pixels which are lined-up in a scanning direction. In this multibeam exposure device, the section which selectively turns on/off the plurality of pixels divides the pixels, which are selectively turned on/off, into a plurality of blocks, and shifts relative positions between the blocks by a predetermined amount.

In accordance with the above-described structure, by the feed addressability improving device, the positions of the plurality of exposure beam spots, which are projected onto the exposure surface from the section which selectively turns the plurality of pixels on/off, are divided into a plurality of blocks on the exposure surface with respect to the feeding direction, and the relative positions between the blocks are shifted by a predetermined amount. The gap positions in the feeding direction at the positions of the plurality of exposure beam spots exposed at one block, are exposed by the plurality of exposure beam spots at another block. In this way, without lowering the relative feeding speed between the photosensitive material and the section which selectively turns the plurality of pixels on/off, the feed addressability can be improved and highly accurate exposure processing can be carried out.

A ninth aspect is a multibeam exposure device wherein a two-dimensional arrangement of exposure beam spots on an exposure surface is divided into a plurality of blocks by a projecting section which is disposed on an optical path from a section which selectively turns on/off the plurality of pixels to the exposure surface, and feed addressability is improved by relatively shifting positions between the plurality of blocks.

In accordance with the above structure, by the projecting section, the positions of the plurality of exposure beam spots, which are projected onto the exposure surface from the section which selectively turns the plurality of pixels on/off, are divided into a plurality of blocks on the exposure surface with respect to the feeding direction, and the relative positions between the blocks are shifted by a predetermined amount. The gap positions in the feeding direction at the positions of the plurality of exposure beam spots exposed at one block, are exposed by the plurality of exposure beam spots at another block. In this way, without lowering the relative feeding speed between the exposure surface and the section which selectively turns the plurality of pixels on/off, the feed addressability can be improved and highly accurate exposure processing can be carried out.

A tenth aspect of the present invention is a multibeam exposure device wherein a two-dimensional arrangement of exposure beam spots on an exposure surface is divided into a plurality of blocks by an optical device which is disposed on an optical path from a light source to the exposure surface, and feed addressability is improved by relatively shifting positions between the plurality of blocks.

In accordance with the above structure, by the optical device, the two-dimensional arrangement of the plurality of exposure beam spots which are projected onto the exposure surface, is divided into a plurality of blocks on the exposure surface with respect to the feeding direction, and the relative positions between the blocks are shifted by a predetermined amount. The gap positions in the feeding direction at the positions of the plurality of exposure beam spots exposed at one block, are exposed by the plurality of exposure beam spots at another block. In this way, without lowering the feeding speed for scanning the exposure surface, the feed addressability can be improved and highly accurate exposure processing can be carried out.

Other objects, features and advantages of the present invention will be apparent to those skilled in the art from the explanation of the preferred embodiment of the present invention illustrated in the appended drawings, and from the appended claims.

### BRIEF DESCRIPTION OF THE DRAWINGS

FIG. 1 is an overall schematic perspective view of an image forming device relating to a first embodiment of a multibeam exposure method and device of the present invention.

FIG. 2 is a schematic perspective view of main portions, showing a state in which a photosensitive material is exposed by exposure heads of an exposure head unit provided at the image forming device relating to the first embodiment of the present invention.

FIG. 3A is a plan view of main portions, showing loci of scanning of reflected light images (exposure beams) by micromirrors in a case in which a DMD is not tilted, and FIG. 3B is a plan view of main portions, showing loci of scanning of exposure beams in a case in which the DMD is tilted, in the image forming device relating to the first embodiment of the present invention.

FIG. 4 is an enlarged perspective view of main portions, showing the structure of the DMD used in the exposure device relating to the first embodiment of the present invention.

FIGS. 5A and 5B are explanatory diagrams for explaining operation of the DMD used in the exposure device relating to the first embodiment of the present invention.

FIG. 6 is a schematic structural diagram of an optical system relating to the exposure head of the image forming device relating to the first embodiment of the present invention.

FIG. 7 is a schematic structural diagram of main portions, showing portions of a microlens array and an aperture array relating to the exposure head of the image forming device relating to the first embodiment of the present invention.

FIG. 8 is a plan view showing the microlens array relating to the exposure head of the image forming device relating to the first embodiment of the present invention.

FIG. 9 is an explanatory diagram showing an exposure processing technique which improves feed addressability, relating to the image forming device relating to the first embodiment of the present invention.

FIG. 10 is an explanatory diagram showing a state in which exposure processing has been carried out with the feed addressability improved, relating to the image forming device relating to the first embodiment of the present invention.

FIG. 11 is an explanatory diagram showing a state of conventional exposure processing, for comparison with the exposure processing technique which improves feed addressability and which relates to the image forming device relating to the first embodiment of the present invention.

FIG. 12 is an explanatory diagram showing the contents of a means for exposure processing which improves feed addressability and which relates to the image forming device relating to the first embodiment of the present invention.

FIG. 13 is a plan view showing a microlens array used in a conventional exposure head, for comparison with the exposure processing technique which improves feed addressability and which relates to the image forming device relating to the first embodiment of the present invention.

FIG. 14 is an explanatory diagram showing a state of exposure processing by a conventional exposure head, for comparison with the exposure processing technique which improves feed addressability and which relates to the image forming device relating to the first embodiment of the present invention.

FIG. 15 is a schematic structural diagram of an optical system relating to an exposure head of an image forming device relating to a second embodiment of the present invention.

FIG. 16 is a schematic structural diagram of an optical system showing another structural example relating to the exposure head of the image forming device relating to the second embodiment of the present invention.

FIG. 17 is a perspective view showing a beam position converting mechanism portion used in the exposure bead of the image forming device relating to the second embodiment of the present invention.

FIG. 18 is a schematic side view showing a height adjusting mechanism portion of the beam position converting mechanism used in the exposure head of the image forming device relating to the second embodiment of the present invention.

FIG. 19 is a plan view showing an arrangement of exposure beam spots for explaining conditions of an angle of inclination, when the DMD is tilted to obtain addressability in a direction orthogonal to a scanning direction in the image forming devices relating to the embodiments of the present invention.

FIG. 20 is a schematic structural diagram of an optical system relating to another structural example relating to the exposure head of the image forming device relating to the first embodiment of the present invention.

FIG. 21 is a sectional view showing a parallel flat plate member, which is substituted for a pair of parallel flat plate members serving as a beam position converting section, in the exposure head of the image forming device relating to the second embodiment of the present invention.

FIG. 22 is a schematic structural perspective view showing a sectional pixel shifting member which utilizes diffraction of light and is used in an exposure head of an image forming device relating to a third embodiment of the present invention,

FIG. 23 is a schematic structural perspective view showing a sectional pixel shifting member of another structure, which utilizes diffraction of light and is used in the exposure head of the image forming device relating to the third embodiment of the present invention.

FIG. 24 is a schematic structural perspective view showing a first diffracting portion used in the sectional pixel shifting member which utilizes diffraction of light in the exposure head of the image forming device relating to the third embodiment of the present invention.

FIG. 25 is a schematic structural perspective view showing a third diffracting portion used in the sectional pixel shifting member which utilizes diffraction of light in the exposure bead of the image forming device relating to the third embodiment of the present invention.

FIG. 26 is a schematic structural perspective view showing a sectional pixel shifting member which utilizes polarization of light in an exposure head of an image forming device relating to a fourth embodiment of the present invention.

FIG. 27 is a schematic structural perspective view showing a sectional pixel shifting member of another structure, which utilizes polarization of light in the exposure head of the image forming device relating to the fourth embodiment of the present invention.

### DETAILED DESCRIPTION OF THE INVENTION

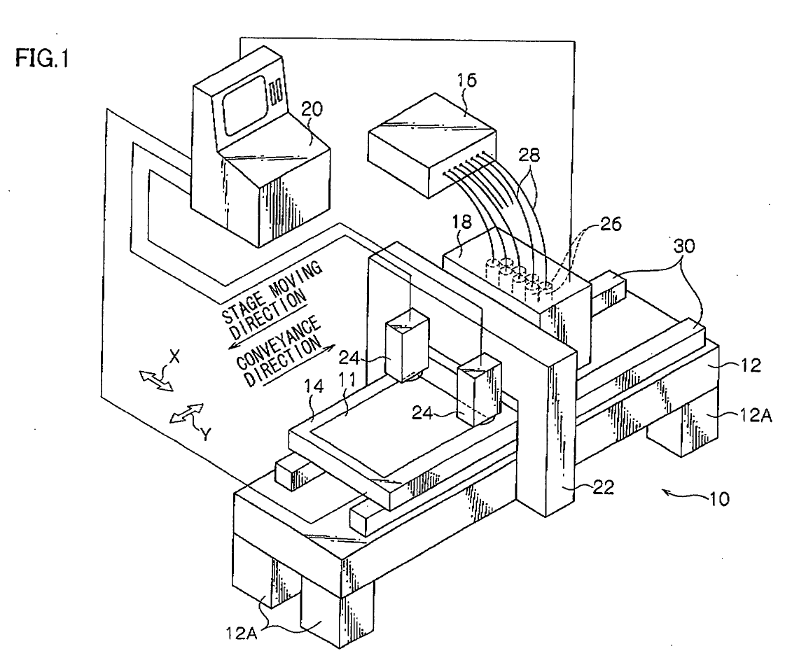

A first embodiment relating to a multibeam exposure method and device of the present invention will be described with reference to FIGS. 1 through 14.

Structure of Image Forming Device

As shown in FIG. 1, an image forming device 10, which is structured as the multibeam exposure device relating to embodiments of the present invention, is a so-called flatbed-type image forming device. The image forming device 10 is structured so as to mainly have a stand 12 supported by four leg members 12A, a moving stage 14, a light source unit 16, an exposure head unit 18 and a control unit 20. The moving stage 14 is provided above the stand 12 and moves in a feeding direction (main scanning direction) indicated by Y in the drawings. The moving stage 14 moves while a photosensitive material, which is structured as, for example, a photosensitive material is placed and fixed on the moving stage 14. The photosensitive material is formed on the surface of a glass substrate such as a printed circuit board (PCB), a color liquid crystal display (LCD), or a plasma display panel (PDP). The light source unit 16 emits, as laser light, multibeams which include the ultraviolet wavelength region and extend in one direction. The exposure head unit 18 spatially modulates the multibeams in accordance with the positions of the multibeams and on the basis of desired image data. The exposure head unit 18 illuminates these modulated multibeams as exposure beams onto the photosensitive material which has sensitivity in the wavelength region of the multibeams. The control unit 20 generates, from the image data, modulating signals which are supplied to respective exposure heads 26 of the exposure head unit 18 as the moving stage 14 moves.

The exposure head unit 18, which is for exposing the photosensitive material, is disposed above the moving stage 14 in the image forming device 10. Bundled optical fibers 28, which are pulled-out from the light source unit 16, are respectively connected to the exposure heads 26 which are disposed within the exposure head unit 18.

A gate-shaped frame 22 which straddles the stand 12 is provided at the image forming device 10. A pair of position detecting sensors 24 is mounted to the both sides of the frame 22. The position detecting sensors 24 supply, to the control unit 20, detection signals at the time when the position detecting sensors 24 sense the passage of the moving stage 14.

Two guides 30, which extend along the stage moving direction, are provided on the stand 12 in the image forming device 10. The moving stage 14 is mounted on the two guides 30 so as to be able to move reciprocatingly. The moving stage 14 is structured so as to be moved over, for example, 1000 mm at a relatively low, constant speed of 40 mm/sec by an unillustrated linear motor.

In the image forming device 10, scan-exposure is carried out while the photosensitive material (substrate) placed on the moving stage 14 is moved in the feeding direction with respect to the exposure head unit 18 which is fixed.

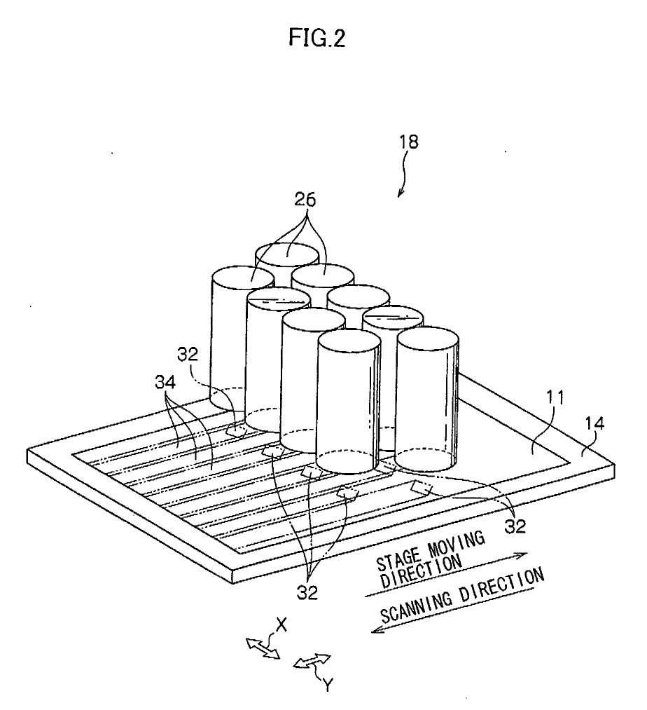

As shown in FIG. 2, a plurality (e.g., eight) of the exposure heads 26, which are arranged in a substantial matrix form of m lines and n columns (e.g., two lines and four columns), are disposed within the exposure head unit 18.

An exposure area 32 of the exposure head 26 is in the shape of a rectangle whose short side runs along the feeding direction (the main scanning direction), for example. In this case, accompanying the motion of the scan-exposure, a strip-shaped exposed region 34 is formed on a photosensitive material 11 by each of the exposure heads 26.

As shown in FIG. 2, the exposure heads 26 of each line, which are lined-up linearly, are disposed so as to be offset by a predetermined interval in the lined-up direction (a natural number multiple of the long side of the exposure area), so that the strip-shaped exposed regions 34 are lined-up, without intervals therebetween, in the direction orthogonal to the scanning direction. Therefore, for example, the portion which cannot be exposed between the exposure area 32 of the first line and the exposure area 32 of the second line can be exposed by the exposure area 32 of the second line.

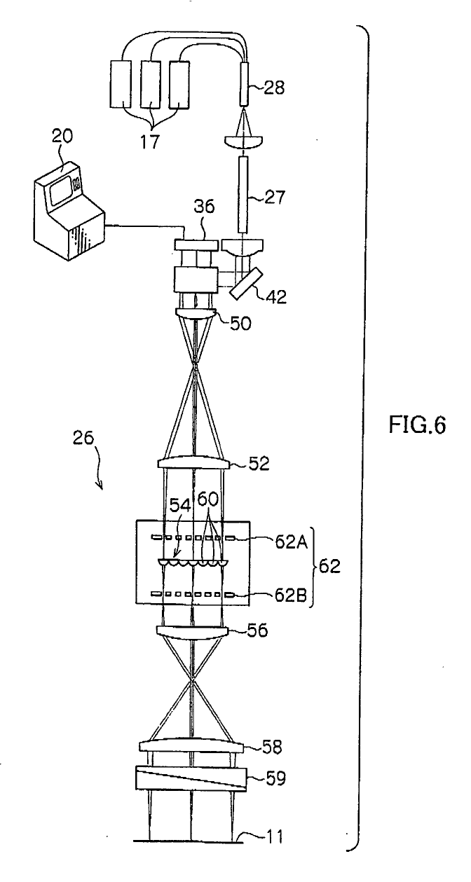

As shown in FIG. 6, each of the exposure heads 26 has a digital micromirror device (DMD) 36 which serves as a spatial light modulator which modulates the light beam incident thereon on a pixel-by-pixel basis in accordance with image data. The DMD 36 is driven and controlled by the control unit (control means) 20 which has a data processing means and a mirror driving controlling means.

The data processing section of the control unit 20 generates control signals for controlling the driving of the respective micromirrors within a region to be controlled of the DMD 36, for each exposure head 26 and on the basis of inputted image data. On the basis of the control signals generated by the image data processing section, the mirror driving control means, which serves as a DMD controller, controls the angles of the reflecting surfaces of the respective micromirrors at the DMD 36 of each exposure head 26.

As shown in FIG. 1, the bundled optical fiber 28 is connected to the light incident side of the DMD 36 of each exposure head 26. The bundled optical fibers 28 are pulled-out from the light source unit 16 which is the illuminating device which emits, as laser light, the multibeams which extend in one direction and include the ultraviolet wavelength region.

As shown in FIG. 6, a plurality of multiplexing modules 17, which multiplex laser lights emitted from a plurality of semiconductor laser chips and input the multiplexed lights to optical fibers, are set at the light source unit 16. The optical fibers extending from the respective multiplexing modules 17 are multiplex optical fibers which propagate the multiplexed laser light. A plurality of the optical fibers are bundled into one and are formed as the bundled optical fiber (fiber bundle) 28.

An illuminating optical system is disposed at the light incident side of the DMD 36 in the exposure head 26. The illuminating optical system passes the laser light exiting from the connected end portion of the bundled optical fiber 28, through an optical lens including a rod lens 27 or the like, and has a mirror 42 which reflects the laser light toward the DMD 36.

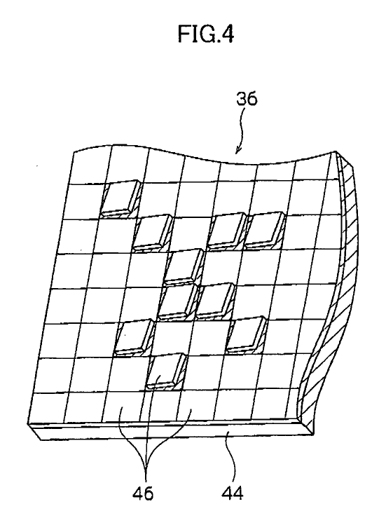

As shown in FIG. 4, in the DMD 36, extremely small mirrors (micromirrors) 46 are disposed on an SRAM cell (memory cell) 44, so as to be supported by unillustrated supports. The DMD 36 is structured as a mirror device in which a large number (e.g., 600 by 800) of the extremely small mirrors which structure pixels are arranged in the form of a grid. The micromirror 46, which is supported at the support at the uppermost portion, is provided at each pixel. A material having high reflectivity, such as aluminum or the like, is deposited on the surface of the micromirror 46.

The SRAM cell 44 of a silicon gate CMOS, which is manufactured on a usual production line for semiconductor memories, is disposed directly beneath the micromirrors 46 via the supports including unillustrated hinges and yokes, so as to be structured monolithically overall.

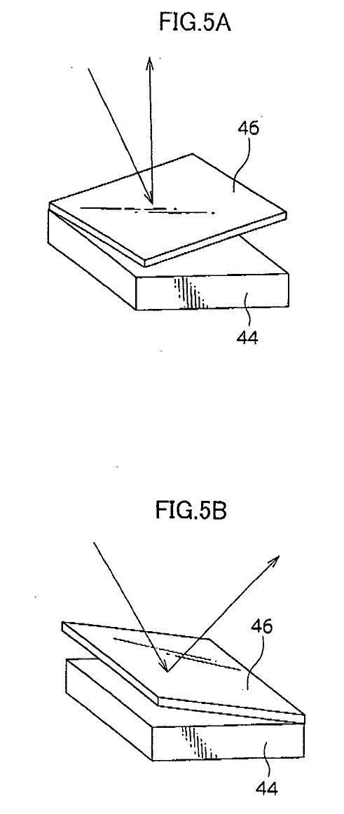

When digital signals are written to the SRAM cell 44 of the DMD 36, the micromirrors 46, which are supported by the supports, are tilted, around diagonal lines, within a range of ±a° (e.g., ±10°) with respect to the substrate on which the DMD 36 is disposed. FIG. 5A illustrates a state in which the micromirror 46 is tilted by +a° which is the on state. FIG. 5B illustrates a state in which the micromirror 46 is tilted by −a° which is the off state. Accordingly, by controlling, as shown in FIG. 4, the inclinations of the micromirrors 46 at the respective pixels of the DMD 36 in accordance with the image signal, the light incident on the DMD 36 is reflected in the directions of tilting of the respective micromirrors 46.

In FIG. 4, a portion of the DMD 36 is enlarged, and an example of a state in which the micromirrors 46 are controlled to +a° and −a° is shown. As described above, the on/off control of the respective micromirrors 46 is carried out by the control unit 20 which is connected to the DMD 36. The light reflected by the micromirror 46 which is in the on state is modulated to an exposure state, and is incident on a projecting optical system (FIG. 6) provided at the light exiting side of the DMD 36. Further, the light reflected by the micromirror 46 which is in the off state is modulated to a non-exposure state, and is incident on a light absorbing body (not illustrated).

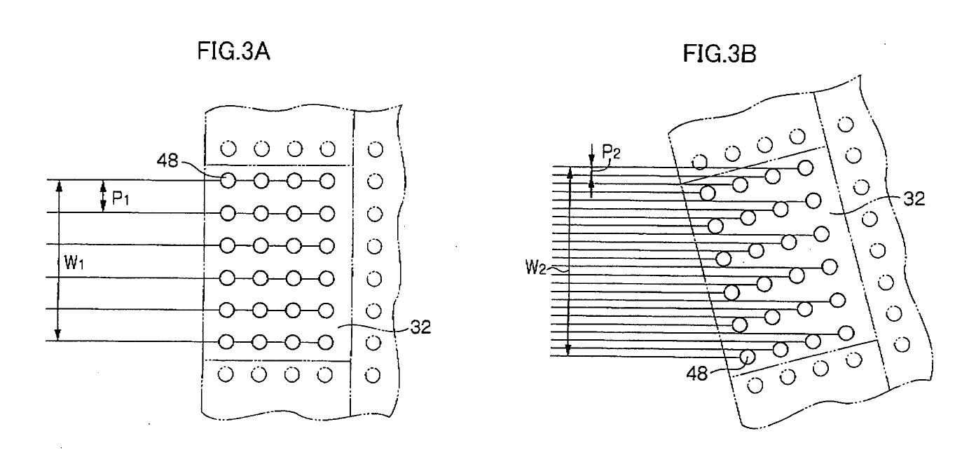

It is preferable that the DMD 36 be disposed so as to be inclined slightly such that the short side direction thereof forms a predetermined angle (e.g., 0.1° to 0.5°) with the scanning direction. FIG. 3A shows the loci of scanning of reflected light images (exposure beams) 48 by the micromirrors in a case in which the DMD 36 is not inclined. FIG. 3B shows the loci of scanning of the exposure beams 48 in a case in which the DMD 36 is inclined.

In the DMD 36, a large number of sets of (e.g., 600 sets of) micromirror columns, in each of which a large number (e.g., 800) of the micromirrors 46 is lined-up in the longitudinal direction (the line direction), is lined-up in the direction of the shorter side. As shown in FIG. 3B, by inclining the DMD 36, a pitch P2 of the loci of scanning (the scan lines) of the exposure beams 48 by the micromirrors 46 is more narrow than a pitch P1 of the scan lines in a case in which the DMD 36 is not inclined, and the resolution can be greatly improved. On the other hand, because the angle of inclination of the DMD 36 is extremely small, a scan width W2 in a case in which the DMD 36 is inclined, and a scan width W1 in a case in which the DMD 36 is not inclined, are substantially the same.

Substantially the same positions (dots) on the same scan line are exposed overlappingly (multiple-exposed) by different micromirror columns. By carrying out multiple exposure in this way, extremely small quantities of the exposure positions can be controlled, and extremely fine exposure can be realized. Further, the junctures between the plural exposure heads which are lined-up in the scanning direction can be connected without steps therebetween by controlling the exposure positions in extremely fine quantities.

Note that similar effects can be achieved if, instead of tilting the DMD) 36, the respective micromirror columns are disposed in a staggered form so as to be offset by predetermined intervals in a direction orthogonal to the scanning direction.

Next, the projecting optical system (image forming optical system) provided at the light reflecting side of the DMD) 36 of the exposure head 26 will be described. As shown in FIG. 6, the image forming optical system (projecting optical system) provided at the light reflecting side of the DMD 36 in each exposure head 26 is structured by optical members for exposure, which are first image forming optical lens systems 50, 52, a microlens array 54 which is an intermediate image forming section, an aperture array 62 which is an intermediate image forming section and is disposed at positions in the vicinities of the front and back of the microlens array 54 on the optical path, second image forming optical lens systems 56, 58, and a prism pair 59 for autofocus, being disposed in that order from the DMD 36 toward the photosensitive material 11, in order to project the light source image onto the photosensitive material 11 which is at the exposure surface disposed at the light reflecting side of the DMD 36.

The first image forming optical lens systems 50, 52 are structured as, for example, enlarging optical systems. By enlarging the cross-sectional area of the light beam bundle reflected by the DMD 36, the surface area, on the photosensitive material 11, of the exposure area 32 (see FIG. 2) by the light beam bundle reflected by the DMD 36 can be enlarged to the needed size.

A plurality of microlenses 60 are formed integrally at the microlens array 54 which is the intermediate image forming section used herein. The microlenses 60 correspond one-to-one to the micromirrors 46 of the DMD 36 which reflects the laser light irradiated from the light source unit 16 through the optical fiber 28. The microlenses 60 are respectively disposed on the optical axes of the laser beams which have passed through the first image forming optical lens systems 50, 52.

As shown in FIG. 6, the microlens array 54 which is the intermediate image forming section is formed in the shape of a rectangular flat plate. A front aperture array 62A, which is the intermediate image forming section, is disposed at a predetermined neighboring position at the light source side on the optical paths at the portion where the respective microlenses 60 are formed. A rear aperture array 62B, which is the intermediate image forming section, is disposed at a predetermined neighboring position at the exposure surface side on the optical paths at the microlens array 54.

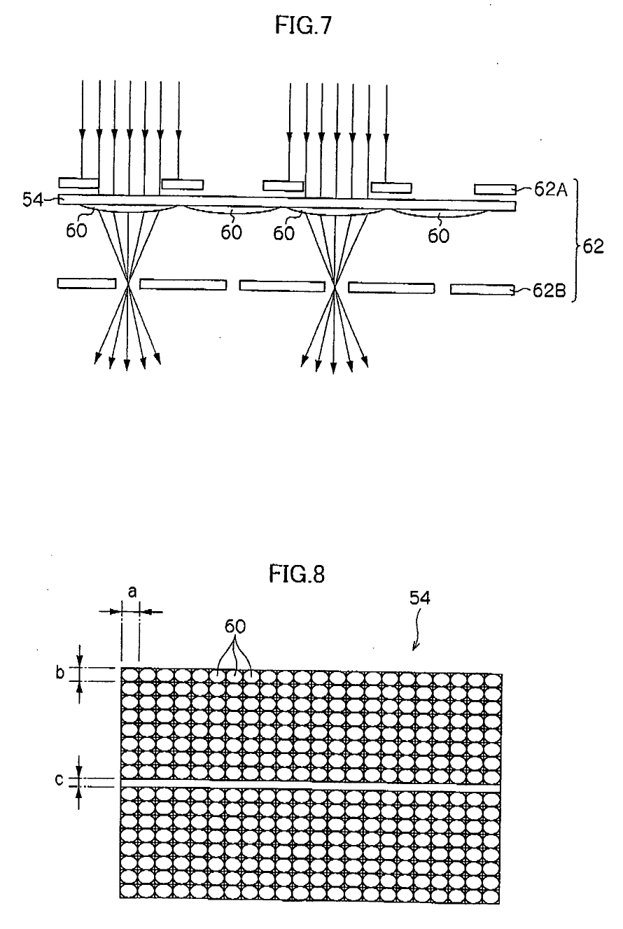

As shown in FIG. 7, the front aperture array 62A, which is disposed at the front side of the microlens array 54 which is the intermediate image forming section, is structured as opening diaphragms whose aperture diameters are formed to a predetermined large diameter and which remove stray light (remove the stray light generated due to the light beams of the respective pixels being incident on the adjacent microlenses 60). The rear aperture array 62B, which is disposed at the rear side of the microlenses 60, is structured as opening diaphragms whose aperture diameters are formed to a predetermined small diameter and which prevent the light beams which are reflected when respective pixels at the DMD 36 are off (i.e., the OFF light) from affecting the exposure surface.

As shown in FIG. 6, the second image forming optical lens systems 56, 58 are structured as, for example, non-magnifying optical systems. The focal points of the light beams projected from the second image forming optical lens systems 56, 58 are matched by the autofocus function of the prism pair 59, and the light beams form images on the photosensitive material 11 disposed on the exposure surface.

Note that, although the first image forming optical lens systems 50, 52 and the second image forming optical lens systems 56, 58 in the projecting optical system are each shown as one lens in FIG. 6, they may be combinations of plural lenses (e.g., a convex lens and a concave lens).

In order to improve the addressability and carry out exposure processing highly accurately without reducing the relative feeding speed between the exposure head 26 and the photosensitive material 11 (the main scanning speed), the image forming device 10 which is structured as described above is provided with a feed addressability improving means. The feed addressability improving means divides, on the exposure surface and into plural blocks with respect to the feeding direction, the plurality of exposure beam spot positions which are projected onto the exposure surface (the surface of the photosensitive material 11) from the exposure head 26 having the DMD 36 which is the means for selectively turning plural pixels on and off, and shifts the relative positions among these blocks by a predetermined amount, and exposes the gaps, in the feeding direction, at the positions of the plural exposure beam spots which expose at one block, by plural exposure beam spots at another block. Note that there is established the relationship that the feed addressability at the time of dividing, into plural blocks on the exposure surface, the positions of the exposure beam spots projected onto the exposure surface from the exposure head 26, is equivalent to the feed addressability, in a case in which the positions are not divided into blocks, divided by the number of block divisions. Therefore, the required feed addressability can be set by appropriately selecting the number of divisions and the original feed addressability.

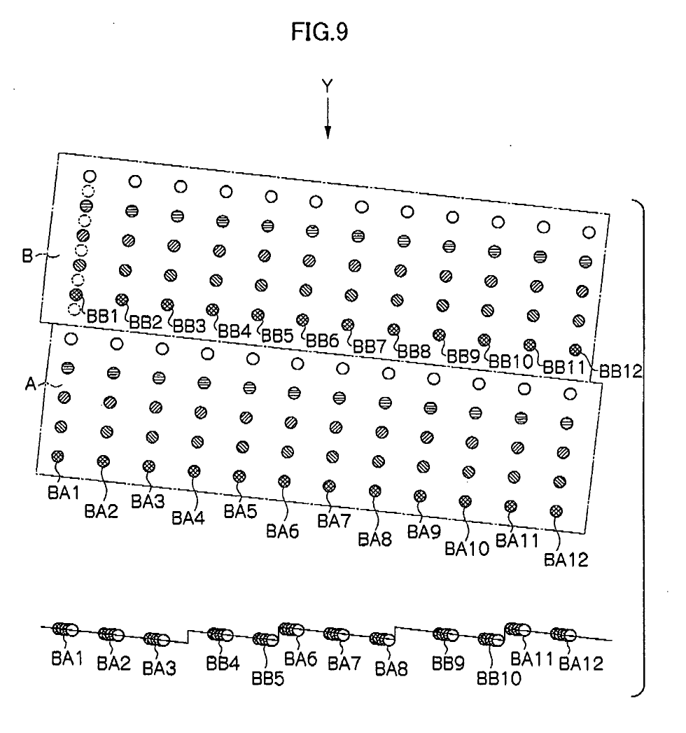

The feed addressability improving means of the present first embodiment is structured by the microlens array 54 which is the intermediate image forming section, and the aperture array 62 which is the intermediate image forming section. As shown in FIG. 8, in the feed addressability improving means relating to the first embodiment, the microlens array 54 is divided uniformly in two with respect to the feeding direction (the main scanning direction), so as to be divided into a first block group 54A and a second block group 54B. The microlens array 54 is structured integrally on the whole in a state in which the border between the first block group 54A and the second block group 54B extends over a predetermined distance.

Namely, the microlens array 54 is structured integrally on the whole with the relative positions between the first block group 54A and the second block group 54B shifted by a predetermined amount. Note that, in the first embodiment, in a two-dimensional arrangement of the exposure beam spots, the amount of shifting between the block of the exposure beam spots by the first block group 54A and the block of the exposure beam spots by the second block group 54B, is a distance which is half of the original feed addressability.

Therefore, at the microlens array 54, pitches a, b of the microlens array are set to be about a=15 μm to 60 μm, b=15 μm to 60 μm, and shift amount (offset amount) c is set to be about c=0.5 μm to 3 μm.

Moreover, the positions of the respective openings formed in the front aperture array 62A and the rear aperture array 62B are set such that the pitches a, b of the microlens array and the shift amount (offset amount) c, which are set in this way, correspond one-to-one. Namely, at the front aperture array 62A and at the rear aperture array 62B which are formed on the whole as an integral structure, the respective apertures are formed so as to correspond to the first block and the second block of the microlens array 54 respectively, and so as to shift the relative positions between the first block and the second block by a predetermined amount.

In the case of such a structure, the centers of the light beams incident on the respective microlenses 60 are offset by about 0.5 μm to 3 μm. However, the offset amount of the centers of the light beams is small as compared with 15 μm to 60 μm which is the pitches a, b of the microlens array. Therefore, the energy loss at the time of exposure processing is made to be small, and the light beams can be shaped appropriately by the front aperture array 62A and the rear aperture array 62B.

Further, in the case of this structure, the arrangement of the respective micromirrors 46 at the DMD 36 may be made to correspond one-to-one to the structure in which the plural microlenses 60 of the microlens array 54 are divided into plural blocks and the relative positions between the blocks are shifted by a predetermined amount. In this case, the optical axes of the respective light beams projected from the micromirrors 46 of the DMD 36 can all be made to be incident on the centers of the corresponding microlenses 60. Therefore, the energy loss of the light beams can be kept to a minimum.

Next, the operation and effects of providing the above-described feed addressability improving means at the exposure head 26 will be described. Here, FIGS. 9 and 12 are drawings for explaining the principles of the operation and effects of the present invention. Further, as shown in FIG. 19, the angle of inclination of the microlens array 54 and the DMD 36 is set to an angle of inclination such that spots overlap at least one time within the range of one block among the plural divisional blocks of the microlens array 54. Namely, in order to obtain addressability in the direction orthogonal to the scanning direction, as shown in FIG. 19, the exposure head 26 is set at an angle such that the first column and the nth column of the exposure beam spots within one block are connected smoothly.

In a case in which exposure processing is carried out by the exposure head 26 provided with the feed addressability improving means in which the microlens array 54 and the aperture arrays 62A, 62B are structured such that the relative positions between the first block and the second block are shifted by a predetermined amount, the two-dimensional arrangement of the exposure beam spots becomes an overall arrangement of a block BA of exposure beam spots by the first block group 54A and a block BB of exposure beam spots by the second block group 54B which is shifted from the block BA by a distance which is half of the original addressability, as shown in FIGS. 9 and 12.

In the two-dimensional arrangement of the exposure beam spots shown in FIGS. 9 and 12, the processing for scan-exposing the photosensitive material 11 is carried out by synchronously on/off controlling all of the micromirrors 46 (elements) of the DMD 36 of the exposure head 26 in correspondence with the modulation period on the basis of the control signals which correspond to the image to be exposed and are transmitted from the control unit 20.

Note that, in a case in which exposure is carried out without using all of the micromirrors 46 of the DMD 36 at the time of scan-exposure (e.g., in a case in which only 256×1024 of the micromirrors 46 are exposed among the 1024-1024 micromirrors 46, or the like), on/off control is carried out by synchronizing all of the micromirrors 46 which are used in the exposure.

Carrying out scan-exposure under the above-described conditions is a state which is equivalent to, while feeding the photosensitive material 11 in the feeding direction (the main scanning direction), exposing by the two-dimensional arrangement of the exposure beam spots of the second block BB so as to overlap on the portions exposed by the two-dimensional arrangement of the exposure beam spots of the first block BA. As shown in FIG. 12, the respective exposure beam spots which are exposed by the two-dimensional arrangement of the second block BB are positioned between the respective exposure beam spots (shown by the imaginary lines in the drawings) which are exposed by the two-dimensional arrangement of the first block BA.

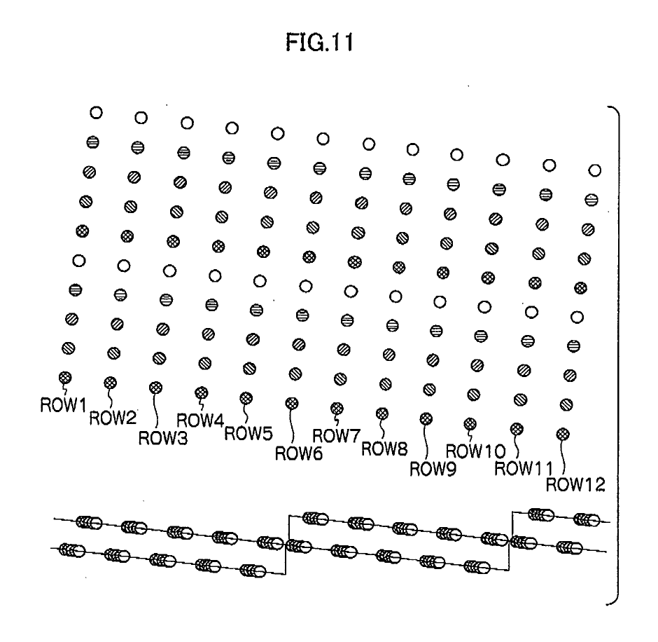

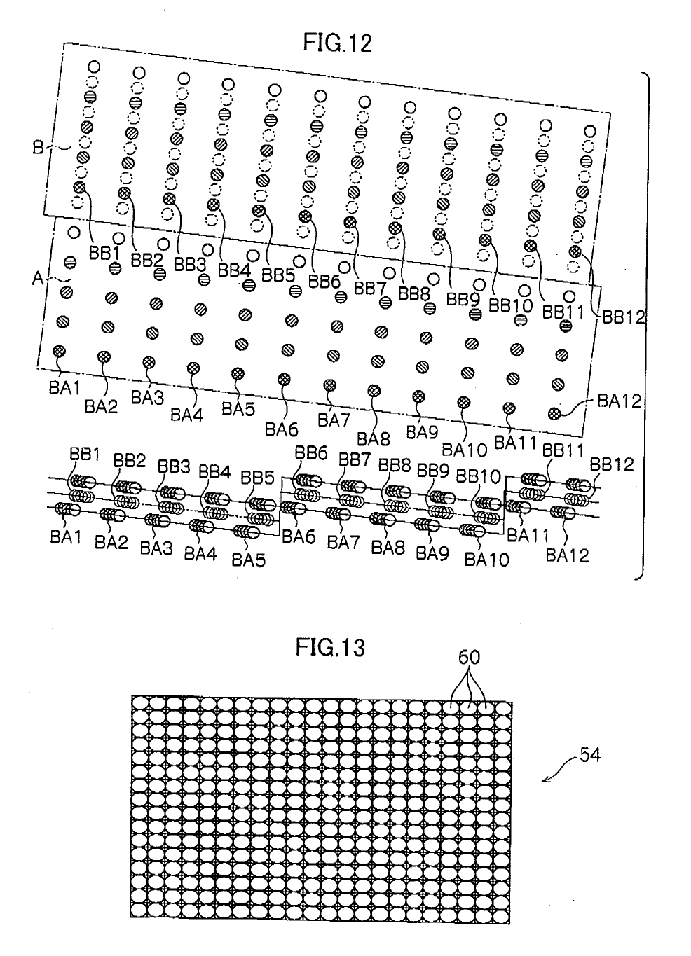

Therefore, as compared with a case in which exposure processing is carried out by the exposure head 26 which is a comparative example using the microlens array 54 in which the microlenses 60 shown in FIG. 13, which are a conventional structure in which all of the exposure beam spots shown in FIG. 11 are arranged two-dimensionally at uniform intervals, are disposed uniformly over the entire surface, the feed addressability (position addressability), which is the addressability of the exposure head 26 with respect to the feeding direction (the main scanning direction), is improved two times in the case of the structure shown in FIG. 12 in which the two-dimensional arrangement of the exposure beam spots is divided into the first block BA and the second block BB and the blocks are shifted with respect to one another.

Next, description will be given of an example of the exposure processing technique which is shown in FIGS. 9 and 12 and which is carried out in order to highly accurately draw straight lines in the direction orthogonal to the feeding direction by the following structure: the DMD 36 is tilted such that the pitch of the scanning loci (scan lines) of the exposure beams 48 by the micromirrors 46 is narrowed and the resolution is greatly improved, and the two-dimensional arrangement of the exposure beam spots is divided into the first block BA and the second block BB which are shifted with respect to one another so as to improve the feed addressability (the position addressability) by twice as much.

In this case, as shown in FIG. 9, the corresponding portions of the straight line (the lateral line) in the direction orthogonal to the feeding direction which is drawn with high accuracy, are drawn by exposure beam spots BA1, BA2, BA3 corresponding to the first line through the third line which are the arrangement in the scanning direction at the first block BA, exposure beam spots BA6, BA7, BA8 corresponding to the sixth line through the eighth line, and exposure beam spots BA11 and BA12 corresponding to the eleventh line and the twelfth line.

Next, when the photosensitive material 11 is moved in the feeding direction and arrives beneath the exposure head 26, the corresponding portions of the straight line in the direction orthogonal to the feeding direction which is drawn with high accuracy, are drawn by exposure beam spots BB4 and BB5 corresponding to the fourth line and the fifth line which are the arrangement in the direction orthogonal to the scanning direction at the second block BB, and exposure beam spots BB9 and BB10 corresponding to the ninth line and the tenth line.

Note that, in the two-dimensional arrangement of the exposure beam spots, the processing of multiple exposure by single or plural exposure beam spots of each line may, of course, be carried out.

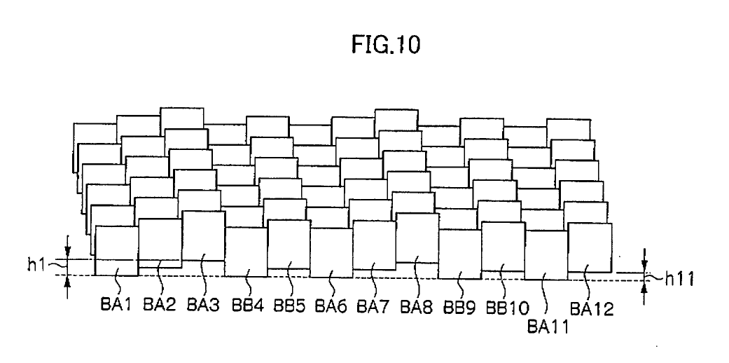

In accordance with the above-described exposure processing technique, the feed addressability (position addressability) becomes twice as high, and, as shown in FIG. 10 in which the state of exposure is seen microscopically, the error can be made to be small by reducing a basic bending amount h1 which affects the fluctuation width of the lateral line (here, the distance of separation, from a lateral line, of the exposure beam spot BA3 which corresponds to the third line of the first block BA) or a basic bending amount h11 which affects the fluctuation width of the lateral line (here, the distance of separation, from a lateral line, of the exposure beam spot BB5 which corresponds to the fifth line of the second block BB).

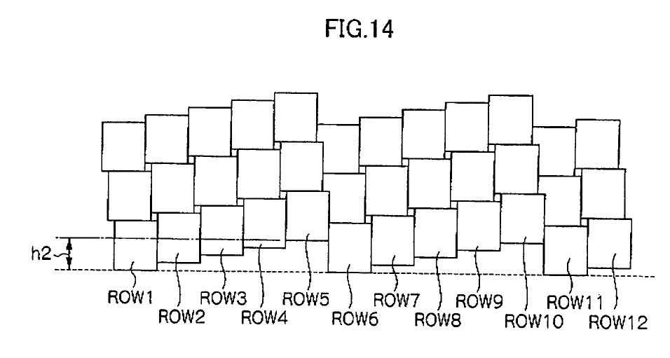

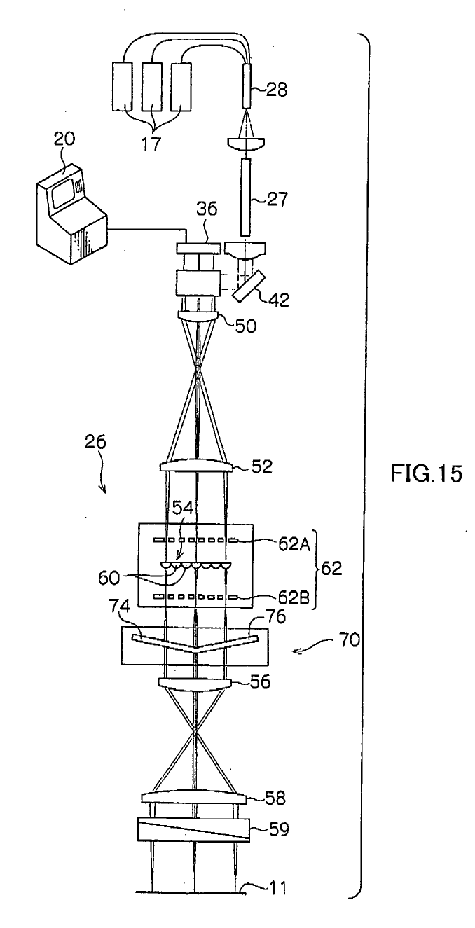

Here, the basic bending amount h1 or h11 is reduced greatly as compared with a basic bending amount h2 which affects the fluctuation width of the lateral line (here, the distance of separation, from a lateral line, of the exposure beam spot which corresponds to the fifth line) in the case shown in FIG. 14 which microscopically shows the state of exposure at the time of exposure processing by the DMD 36 which is a comparative example of a conventional structure in which all of the exposure beam spots are arranged two-dimensionally at uniform intervals as shown in FIG. 11. Therefore, it can be confirmed that straight lines can be drawn even more accurately.

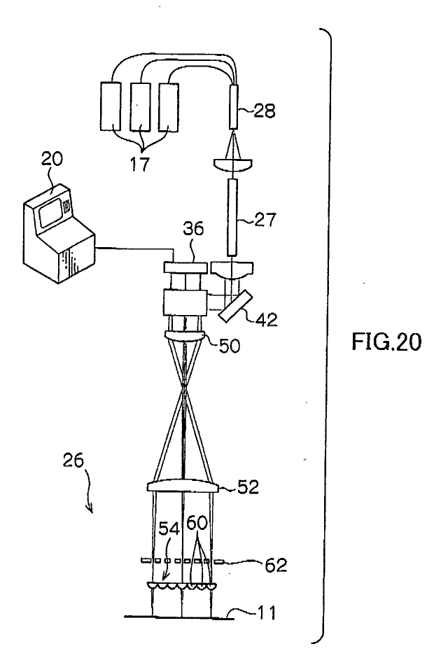

In addition to the above-described structure shown in FIG. 6, each of the exposure heads 26 may be structured as shown in FIG. 20. In the case of the structure shown in FIG. 20, the microlens array 54 is provided at the image forming surface of the image forming optical lens systems 50, 52, and the exposure surface (the surface at which the photosensitive material 11 is positioned) is provided at the focal point position of the microlens array 54. Namely, as compared with the structure of the exposure head 26 shown in FIG. 6, in the exposure head 26 shown in FIG. 20, the optical member further toward the exposure surface than the rear aperture array 62B is omitted, and the exposure surface is set at the focal point position of the microlens array 54. In this structure, because the exposure surface (the photosensitive material 11) is disposed at the focal point position of the microlens array 54 at which the beams of the respective pixels are collected, exposure of a higher resolution can be carried out as compared with the structure of FIG. 6.

Operation of the Image Forming Device

Operation of the image forming device 10, which is structured as described above, will be described next.

At the light source unit 16 which is a fiber array light source provided at the image forming device 10, there are provided a plurality of multiplexing modules which multiplex laser beams such as ultraviolet rays or the like emitted from plural semiconductor laser chips, and input the multiplexed laser beams to optical fibers, although this is not illustrated. The optical fibers extending from the respective multiplexing modules are multiplex optical fibers which propagate the multiplexed laser light. A plurality of the optical fibers are bundled into one and are formed as the bundled optical fiber (fiber bundle) 28, such that the intensity of the emitted laser light is improved.

In this image forming device 10, image data corresponding to an exposure pattern is inputted to the control unit 20 which is connected to the DMD 36, and is stored once in a memory within the control unit 20. This image data is data which expresses binarily (the absence/presence of dot recording), the density of each pixel forming the image.

The moving stage 14, which sucks the photosensitive material 11 to the surface thereof, is moved by an unillustrated driving device at a constant speed along the guides 30 from the conveying direction upstream side to the downstream side. When, at the time when the moving stage 14 passes beneath the gate-shaped frame 22, the leading end of the photosensitive material 11 is detected by the position detecting sensors 24 mounted to the gate-shaped frame 22, the image data stored in the memory is successively read-out in units of plural lines. The control device serving as the data processing section generates, for each exposure head 26, a control signal (control data) which can improve the required feed addressability, in accordance with the fact that the two-dimensional arrangement of the exposure beam spots is, by the above-described feed addressability improving means and on the basis of the read image data, divided into plural blocks and the blocks are shifted by a predetermined distance with respect to one another.

Then, the respective micromirrors of the spatial light modulator (DMD) 36 are on/off controlled at each exposure head 26 on the basis of the generated control signal.

When the laser light is irradiated onto the spatial light modulator (DMD) 36 from the light source unit 16, the laser lights, which are reflected when the micromirrors of the DMD 36 are in on states, are image-formed at the requisite exposure beam spot positions at which the feed addressability is improved. In this way, the laser light exiting from the light source unit 16 is turned on and off per pixel, and the photosensitive material 11 is subjected to exposure processing in a state in which the feed addressability is improved at a predetermined feeding speed in the main scanning direction (a state in which the feed addressability is improved without slowing down the feeding speed which is the moving speed of the moving stage 14).

Due to the photosensitive material 11 being moved together with the moving stage 14 at a constant speed, the photosensitive material 11 is scanned by the exposure head unit 18 in the direction opposite to the moving direction of the stage, and the strip-shaped exposed region 34 (see FIG. 2) is formed by each exposure head 26.

When scanning of the photosensitive material 11 by the exposure head unit 18 is completed and the trailing end of the photosensitive material 11 is detected by the position detecting sensors 24, the moving stage 14 is returned along the guides 30 by the unillustrated driving device to its origin which is at the most upstream side in the conveying direction, and is again moved at a constant speed along the guides 30 from the conveying direction upstream side to the downstream side.

The image forming device 10 relating to the present embodiment uses a DMD as the spatial light modulator used in the exposure head 26. However, instead of the DMD, it is possible to use, for example, a MEMS (Micro Electro Mechanical System) type spatial light modulator (SLM), or a spatial light modulator other than a MEMS type, such as an optical element which modulates transmitted light by the electrooptical effect (a PLZT element), a liquid crystal light shutter (FLC), or the like.

Further, the spatial light modulator used in the present embodiment is not limited to a spatial light modulator which can be set only in on and off states. A spatial light modulator which, in addition to on and off states, can assume plural intermediate values so as to be able to express the gradation, may be used.

Note that “MEMS” collectively refers to minute systems in which micro-sized sensors, actuators and control circuits, which are formed by micromachining techniques based on IC manufacturing processes, are integrated. A MEMS type spatial light modulator means a spatial light modulator which is driven by electromechanical operation using static electricity.

The image forming device 10 relating to the present embodiment may be structured by replacing the spatial light modulator (DMD) 36 used in the exposure head 26 with a means for selectively turning a plurality of pixels on and off. The means for selectively turning a plurality of pixels on and off may be structured by, for example, a laser light source which can selectively turn on and off and emit laser beams corresponding to respective pixels. Or, the means for selectively turning a plurality of pixels on and off may be structured by a laser light source in which a planar light-emitting laser element is formed by disposing minute laser light emitting surfaces in correspondence with respective pixels, and which can emit light by selectively turning the respective minute laser light emitting surfaces on and off.

Next, a second embodiment relating to the multibeam exposure device of the present invention will be described with reference to FIGS. 15 through 18.

In the present second embodiment, the feed addressability improving means provided at the exposure head 26 is structured by a beam position converting means which is disposed on the optical path, further toward the exposure surface than the microlens array 54 and the aperture arrays 62A, 62B.

This beam position converting means is structured so as to be disposed on the optical paths of the plural exposure beams projected onto the exposure surface from the DMD 36 at the existing optical system at the usual exposure head 26, and so as to tilt and insert parallel flat plates, which correspond respectively to the plural blocks which have been divided with respect to the feeding direction, so as to shift the relative positions between the blocks by a predetermined amount, and shift the beam positions. Namely, as shown in FIG. 15, a beam position converting mechanism 70 is disposed on the optical path of the exposure head 26 between, on the one hand, the microlens array 54 and the aperture arrays 62A, 62B, and, on the other hand, the second image forming optical systems 56, 58 which are further toward the exposure surface than the microlens array 54 and the aperture arrays 62A, 62B.

In the same way as in the previously-described first embodiment, the illustrated beam position converting mechanism 70 is structured so as to divide, on the exposure surface and into two block groups with respect to the feeding direction, the plurality of exposure beam spot positions which are projected from the exposure head 26 onto the exposure surface (the surface of the photosensitive material 11), and shift the relative positions among these blocks by a predetermined amount, and expose the gaps, in the feeding direction, at the positions of the plural exposure beam spots which expose at one block, by plural exposure beam spots of another block.

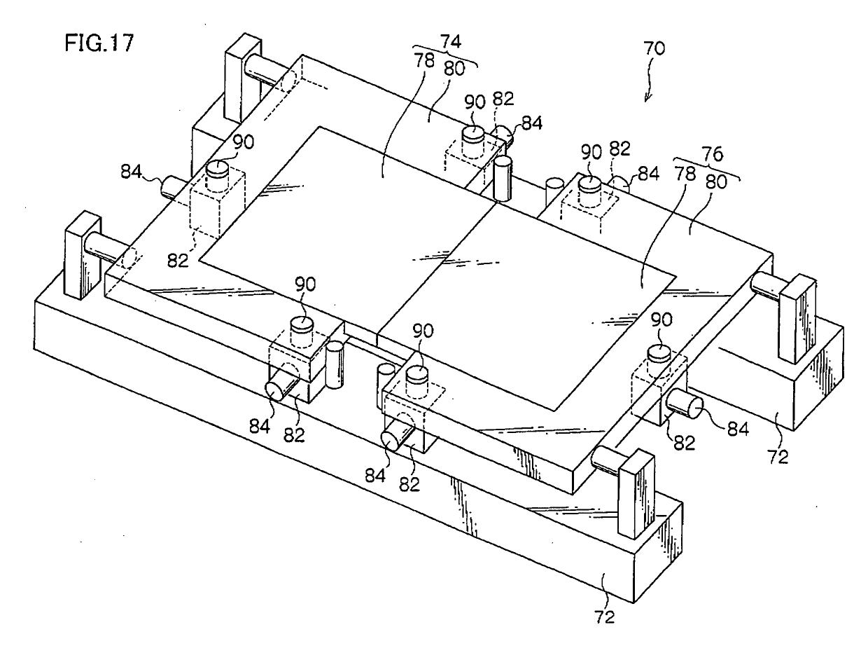

At the exposure head 26, the light beams which have passed through the microlens array 54 are not parallel light. Therefore, because parallel flat plates cannot be set only at one portion of the microlens array 54, parallel flat plates of uniform thicknesses must be set to as to correspond to the entire surface of the microlens array 54. Thus, as shown in FIG. 17, the beam position converting mechanism 70 is structured such that a pair of parallel flat plate members 74, 76 are mounted on a single stand 72.

The pair of parallel flat plate members 74, 76 are structured by integrally providing substantially U-shaped frames 80 at the outer peripheries of transmitting members 78 which are shaped as rectangular flat plates and through which light beams pass. The pair of parallel flat plate members 74, 76 are each mounted on the stand 72 in a state of being supported at three points, via three height adjusting mechanisms 82 which are disposed so as to support portions of the respective frames 80.

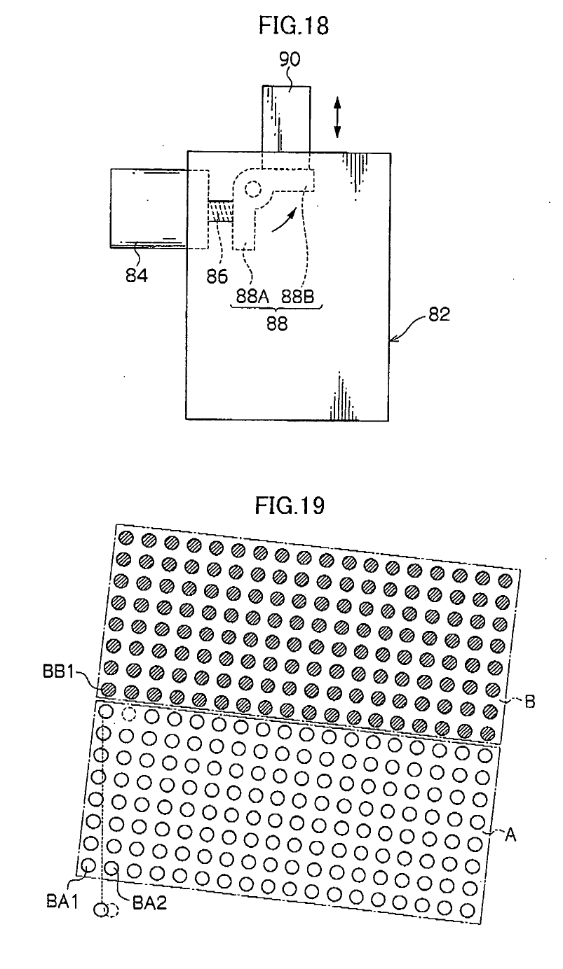

As shown in FIG. 18, the height adjusting mechanism 82 is structured such that the distal end of a screw shaft 86, which is operated by a motor 84 so as to finely extend and contract, is made to abut a vertical arm portion 88A of an operation direction converting member 88 which is formed in a V-shape and whose bent portion is pivotally attached to a fixed member such as an unillustrated frame or the like. A solid cylindrical holding member 90 is mounted to a horizontal arm portion 88B of the operation direction converting member 88. The holding member 90 of the height adjusting mechanism 82 is mounted to the corresponding frame 80.

Three of the height adjusting mechanisms 82, which are structured in this way, form a set and support the parallel flat plate members 74, 76 in a state of being supported at three points, respectively. At this time, at the respective height adjusting mechanisms 82, an unillustrated control device drives and controls the motors 84, such that the amounts of projection of the holding members 90 are adjusted via the screw shafts 86 and the operation direction converting members 88. In this way, the transmitting members 78 of the parallel flat plate members 74, 76, which are each supported at three points by the three height adjusting mechanisms 82, are adjusted to the required angles of inclination with respect to the light beams and are set unconditionally.

Accordingly, at the beam position converting means, by adjusting the angles of inclination of the respective parallel flat plate members 74, 76, the two-dimensional arrangement of the exposure beam spots is divided into a first block passing through the one parallel flat plate member 74 and a second block passing through the other parallel flat plate member 76, and the interval between the first block and the second block is set to the needed interval. Namely, at the beam position converting means, the two-dimensional arrangement of the exposure beam spots is divided into the first block and the second block which are shifted with respect to one another, such that the feed addressability (position addressability) is improved to twice as much.

The above-described first embodiment describes a case in which the two-dimensional arrangement of the exposure beam spots is divided into two blocks. However, the present invention is not limited to the same, and may be structured such that the two-dimensional arrangement of the exposure beam spots is divided into three or more blocks. When the two-dimensional arrangement of the exposure beam spots is divided into three or more blocks in this way, an even higher feed addressability can be obtained while the scanning speed is maintained at a high speed.

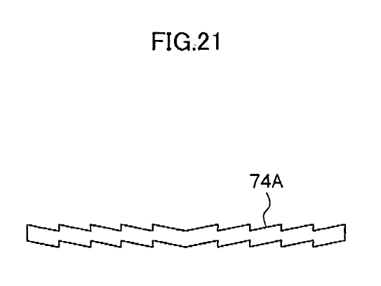

Further, the pair of parallel flat plate members 74, 76 used in the present second embodiment are structured by assembling together the parallel flat plate member 74 and the parallel flat plate member 76, which are formed as separate, flat-plate-shaped members, such that respective one sides thereof contact one another and the parallel flat plate members 74, 76 respectively form the needed angle of inclination with respect to the light beams. However, as shown in FIG. 21, the pair of parallel flat plate members 74, 76 may be replaced by a parallel flat plate member 74A, which is structured by a plurality of small parallel flat plates, which form a predetermined angle of inclination with respect to the light beams, being formed integrally in a zigzag manner so as to be thin in the optical axis direction of the light beams, and so as to have left-right symmetry with respect to a central line.

When this parallel flat plate member 74A, which is structured in this way and is thin in the optical axis direction, is used, it occupies very little space in the optical axis direction. Therefore, the parallel flat plate member 74 can be set in a narrow space, and is effective in making the exposure head 26 more compact.

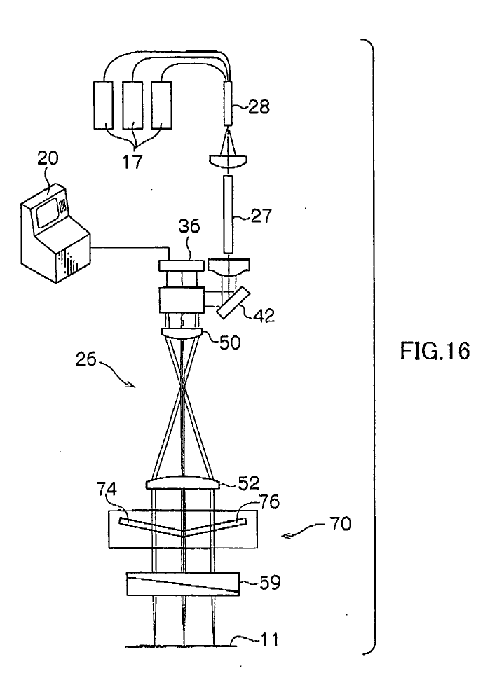

Next, another structural example relating to the second embodiment of the multibeam exposure device of the present invention will be described in accordance with FIG. 16.

In the structural example shown in FIG. 16, the beam position converting means provided at the exposure head 26 is disposed on the optical path, further toward the exposure surface than the first image forming optical lens systems 50, 52. Namely, on the optical path of the exposure head 26 shown in FIG. 15, an image is formed once on the microlens array 54, but in the structural example shown in FIG. 16, this image forming position on the microlens array 54 is set to be the exposure surface.

Therefore, the microlens array and the apertures are omitted from the exposure head 26, the beam position converting mechanism 70 is disposed on the optical path further toward the exposure surface than the first image forming optical lens systems 50, 52, and the prism pair 59 is disposed on the optical path even further toward the exposure surface.

This exposure head 26 can carry out exposure with the feed addressability (position addressability) improved by two times, due to the beam position converting mechanism 70 dividing the two-dimensional arrangement of the exposure beam spots into the first block and the second block on the photosensitive material 11, and shifting the first block and the second block with respect to one another.

The structures, operations, and effects of the present second embodiment, other than those described above, are similar to those of the first embodiment, and therefore, description thereof will be omitted.

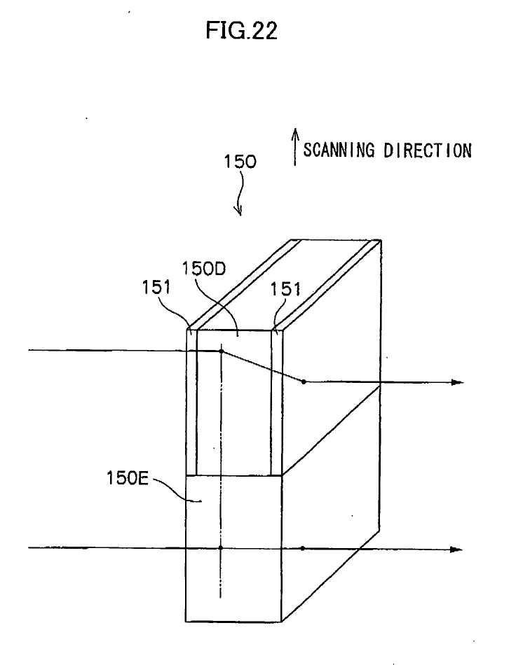

Next, a third embodiment relating to the multibeam exposure device of the present invention will be described with reference to FIGS. 22 through 25.

In the present third embodiment, an optical element, which utilizes diffraction of light, is used as the beam position converting section which is disposed on the optical path and is the feed addressability improving device provided at the exposure head 26. For this optical element which utilizes diffraction, it is possible to use an element formed by blazing a hologram or a binary optical element (diffracting member) (an element in which grooves of a grid, which has an inclined, planar, smooth surface at its obverse, are formed one-by-one in accordance with angles which are known as groove angles, such that the spectral energy is concentrated in a single angular range, i.e., an element which is worked into the shape of an optical surface at a given angle, such as in the shape of a sawtooth blade), or the like.

Here, a bean position converting section using a binary optical element is shown in FIGS. 22 through 25.

This beam position converting section is structured by a binary optical element which is disposed on the optical paths of the plurality of exposure beams which are projected onto the exposure surface from the DMDs 36 at the existing optical system at the ordinary exposure head 26. Namely, the beam position converting section is structured by a sectional pixel shifting member 150 which is a binary optical element structured as an optical element utilizing the diffraction of light, and which is disposed in place of the beam position converting mechanism 70 which is on the optical path between, on the one hand, the microlens array 54 and the aperture arrays 62A, 62B, and, on the other hand, the second image forming optical lens systems 56, 58 which are further toward the exposure surface side than the microlens array 54 and the aperture arrays 62A, 62B, in the above-described exposure head 26 shown in FIG. 15.

In the same way as in the above-described embodiment, the sectional pixel shifting member 150 divides, into two blocks with respect to the feeding direction and on the exposure surface, the positions of the plurality of exposure beam spots which are projected onto the exposure surface (the surface of the photosensitive material 11) from the exposure head 26, and shifts the relative positions between these blocks by a predetermined amount, and can expose the gaps, in the feeding direction, at the positions of the plural exposure beam spots which expose at one block, by plural exposure beam spots at another block.

Therefore, the sectional pixel shifting member 150, which is illustrated in FIG. 22 and is structured by an optical element utilizing the diffraction of light, is structured by dividing a single planar plate, which is optical glass or the like and is transparent and formed as a planar member of the same thickness, into two areas (portions), which are an upper level and a lower level, with respect to the scanning direction (the main scanning direction), and the upper level is a first diffracting portion 150D and the lower level is a second transmitting portion 150E.

The second transmitting portion 150E is structured such that the light beams pass therethrough along rectilinear optical paths.

The lengths, with respect to the direction orthogonal to the scanning direction (feeding direction), of the first diffracting portion 150D and the second transmitting portion 150E (i.e., the distances from the boundary surface between the first diffracting portion 150D and the second transmitting portion 150E to the respective free ends), are set to be greater than or equal to lengths obtained by dividing, into two equal parts, the optical path width corresponding to the direction orthogonal to the scanning direction (feeding direction) of the optical path from all of the micromirror 46 groups of the DMD 36, at the position where the sectional pixel shifting member 150 is disposed, to the exposure surface (the surface of the photosensitive material 11).

Moreover, the sectional pixel shifting member 150 shown in FIG. 22 is disposed such that the central position of the boundary surface between the first diffracting portion 150D and the second transmitting portion 150E, coincides with the central position of the optical path width corresponding to the direction orthogonal to the scanning direction of the optical path from all of the micromirror 46 groups of the DMD 36, at the position where the sectional pixel shifting member 150 is disposed, to the exposure surface.

In accordance with this arrangement and structure, the sectional pixel shifting member 150 divides the micromirror 46 groups of the DMD 36, which are arranged two-dimensionally, into two equal parts with respect to the scanning direction on the exposure surface (the number of beam spots with respect to the scanning direction is divided equally in two), such that two blocks can be set.

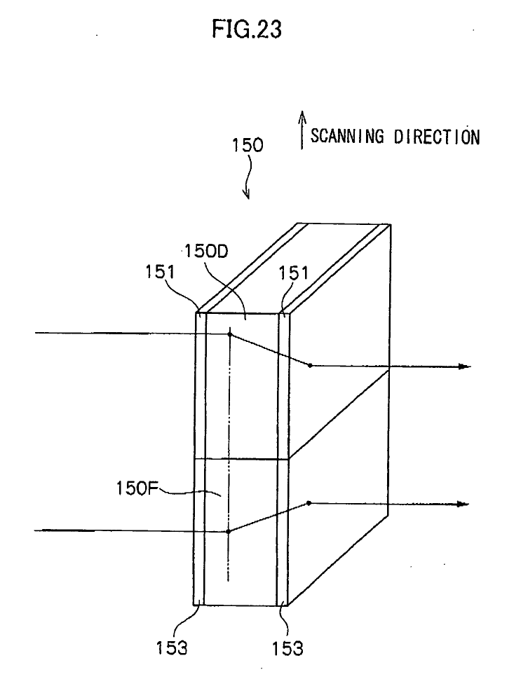

The sectional pixel shifting member 150, which is shown in FIG. 23 and is structured as an optical element utilizing the diffraction of light, is structured by dividing a single planar plate, which is optical glass or the like and is transparent and formed as a planar member of the same thickness, into two areas (portions), which are an upper level and a lower level, with respect to the scanning direction (the main scanning direction), and the upper level is the first diffracting portion 150D and the lower level is a third diffracting portion 150F.

In accordance with this arrangement and structure, the sectional pixel shifting member 150 shown in FIG. 23 divides the micromirror 46 groups of the DMD 36, which are arranged two-dimensionally, into two equal parts with respect to the scanning direction on the exposure surface (the number of beam spots with respect to the scanning direction is divided equally in two), such that two blocks can be set at a shift amount which is greater than (e.g., two times larger than) that of the above-described sectional pixel shirting member 150 shown in FIG. 22.

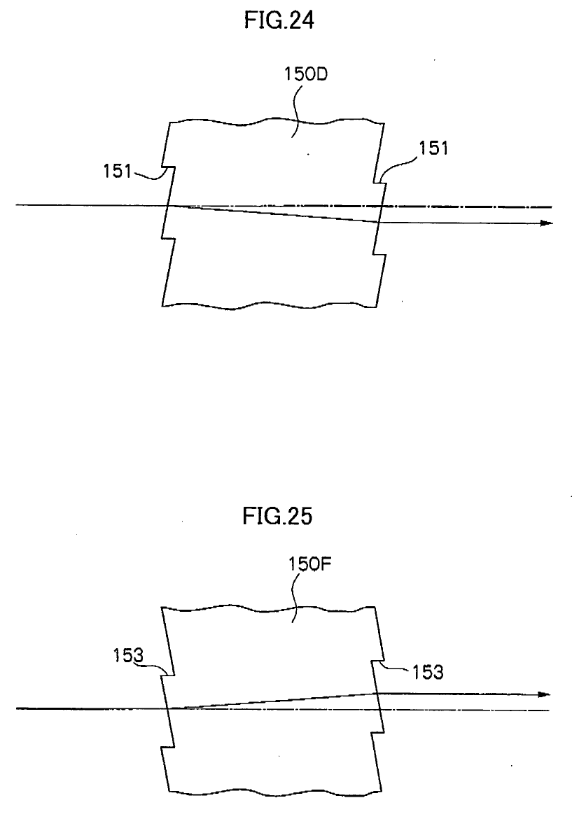

In the sectional pixel shifting member 150, which is illustrated in FIG. 22 or in FIG. 23 and which is structured as an optical element utilizing the diffraction of light, both the obverse and the reverse of the first diffracting portion 150D are structured by first BOEs (binary optical elements) 151 which work to diffract the light beams as shown in FIG. 24 and shift the beam spots by a predetermined amount one way in the scanning direction.

Further, both the obverse and the reverse of the third diffracting portion 150F are structured by second BOEs (binary optical elements) 153 which work to diffract the light beams as shown in FIG. 25 and shift the beam spots by a predetermined amount the other way in the scanning direction.

These first BOEs 151 and second BOEs 153 are formed by being machined as generally used binary optical elements (diffracting members). For example, the first BOEs 151 and second BOEs 153 can be structured by machining inclined surfaces, which are respectively minute in cross-sectional view, in both the obverse and reverse portions of the first diffracting portion 150D and the third diffracting portion 150F at the plate-shaped optical glass forming the sectional pixel shifting member 150. (In actuality, so-called etching machining is carried out repeatedly so as to form minute step-shaped inclines at concave portions.)

The first BOEs 151 and second BOEs 153 are structured, at both the obverses and reverses of the first diffracting portion 150D and the third diffracting portion 150F, as minute inclined surfaces which are substantially triangular in cross-section and which extend rectilinearly from one end portion in the direction orthogonal to the scanning direction to the other end portion. The first BOEs 151 and second BOEs 153 are structured such that the height of the minute, substantially triangular cross-section (the height of the step) is an integer multiple of the following formula, given that the refractive index of the diffracting member is n, the refractive index of the air is 1, the wavelength of the light is λ, and the number of steps is N:
λ/(n−1)*(N−1)/N formula (1).

Theoretically, when the number (levels) of the minute step portions formed at inclines in the concave portions of the first BOEs 151 and second BOEs 153 respectively are inclined surfaces of eight levels, the proportion of light which is diffracted in a predetermined direction at the first BOEs 151 and second BOEs 153 is about 95%, and is about 98.7% in the case of inclined surfaces of 16 levels, and is 99.5% in the case of 32 levels. Accordingly, the first BOEs 151 and second BOEs 153 can sufficiently withstand actual use by being machined to about 16 levels or 32 levels in accordance with the stray light limit at the exposure surface.

In the sectional pixel shifting member 150 shown in FIG. 23, the first diffracting portion 150D provided with the first BOEs 151, and the third diffracting portion 150F provided with the second BOEs 153, are structured such that the directions of inclination of the binary optical elements are opposite, as can be understood by comparing FIG. 24 and FIG. 25. The direction of diffracting the light beams and shifting the beam spot positions at the first BOEs 151, and the direction of diffracting the light beams and shifting the beam spot positions at the second BOEs 153, are opposite directions.

By changing and adjusting the respective thicknesses of the first diffracting portion 150D provided with the first BOEs 151 and the third diffracting portion 150F provided with the second BOEs 153, the amounts of shifting of the positions of the beam spots which are illuminated on the exposure surface of the photosensitive material 11 can be set to predetermined amounts.

In the sectional pixel shifting members 150, which serve as beam position converting sections and which are structured as described above, the two-dimensional arrangement of the exposure beam spots is divided into a first block, which passes through the one first diffracting portion 150D, and a second block, which passes through the other second transmitting portion 150E or third diffracting portion 150F, and the gap between the first block and the second block is set to the needed gap. Namely, in this beam position converting section, the two-dimensional arrangement of the exposure beam spots is divided into the first block and the second block, and the blocks are shifted with respect to one another, and the feed addressability (the position addressability) can be improved two times.

Although not illustrated, the sectional pixel shifting member may be structured so as to be divided into a combination of three blocks with the second transmitting portion 150E disposed between the first diffracting portion 150D and the third diffracting portion 150F, and the blocks shifted with respect to one another.

Structures, operations, and effects of the present third embodiment which are other than those described above, are similar to those of the above-described first and second embodiments, and therefore, description thereof will be omitted.

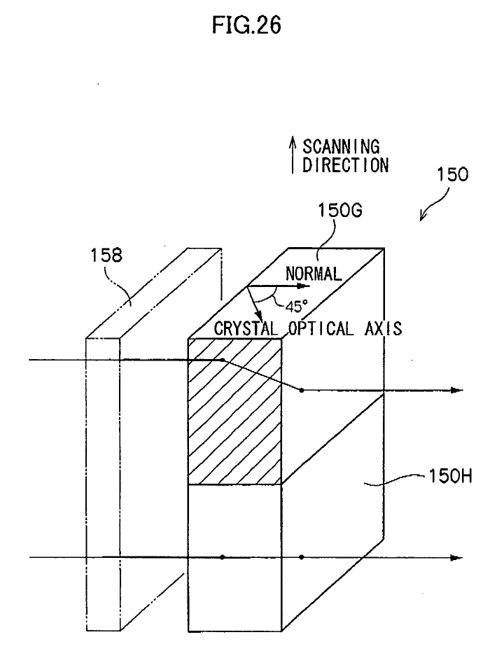

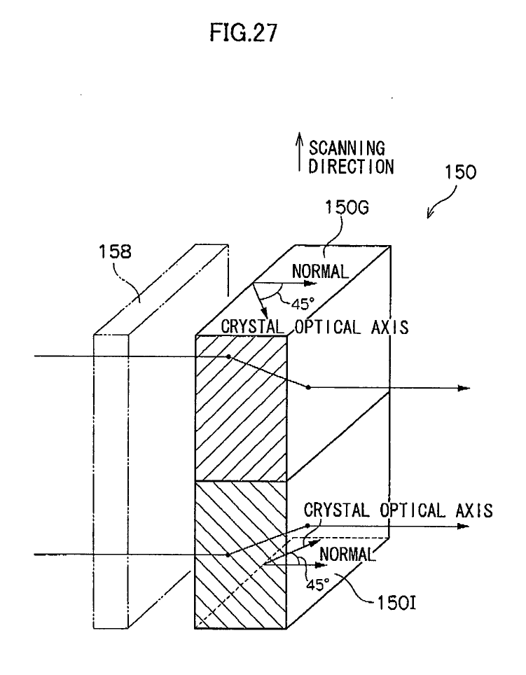

Next, a fourth embodiment relating to the multibeam exposure device of the present invention will be described with reference to FIGS. 26 and 27.

The present fourth embodiment uses an optical element, which utilizes polarization of light, as the beam position converting section which is disposed on the optical path and which is the feed addressability improving device provided at the exposure head 26.

The sectional pixel shifting member 150, which is shown in FIG. 26 and is structured as an optical element utilizing polarization of light, is formed as a planar plate which is transparent and has the same thickness, and is divided into two areas (portions), which are an upper level and a lower level, with respect to the direction orthogonal to the scanning direction (the main scanning direction). The upper level is a first polarizing portion 150G, and the lower level is a second transmitting portion 150H.

The second transmitting portion 150H is structured such that the light beams pass therethrough along rectilinear optical paths.

The lengths, with respect to the direction orthogonal to the scanning direction (feeding direction), of the first polarizing portion 150G and the second transmitting portion 150H, are set to be greater than or equal to lengths obtained by dividing, into two equal parts, the optical path width corresponding to the direction orthogonal to the scanning direction (feeding direction) of the optical path from all of the micromirror 46 groups of the DMD 36, at the position where the sectional pixel shifting member 150 is disposed, to the exposure surface (the surface of the photosensitive material 11).

Moreover, the sectional pixel shifting member 150 is disposed such that the central position of the length, with respect to the scanning direction, of the boundary surface between the first polarizing portion 150G and the second transmitting portion 150H, coincides with the central position of the optical path width corresponding to the direction orthogonal to the scanning direction of the optical path from all of the micromirror 46 groups of the DMD 36, at the position where the sectional pixel shifting member 150 is disposed, to the exposure surface.

In accordance with this arrangement and structure, the sectional pixel shifting member 150 divides the micromirror 46 groups of the DMD 36, which are arranged two-dimensionally, into two equal parts with respect to the scanning direction on the exposure surface (the number of beam spots with respect to the scanning direction is divided equally in three), such that two blocks which are divided equally can be set.

The sectional pixel shifting member 150, which is shown in FIG. 27 and is structured as an optical element utilizing polarization of light, is formed as a planar plate which is transparent and has the same thickness, and is divided into two areas (portions), which are an upper level and a lower level, with respect to the direction orthogonal to the scanning direction (the main scanning direction). The upper level is the first polarizing portion 150G and the lower level is a third polarizing portion 150I.

In accordance with this arrangement and structure, the sectional pixel shifting member 150 shown in FIG. 27 divides the micromirror 46 groups of the DMD 36, which are arranged two-dimensionally, into two equal parts with respect to the scanning direction on the exposure surface (the number of beam spots with respect to the scanning direction is divided equally in two), such that two blocks can be set at a shift amount which is greater than (e.g., two times larger than) that of the above-described sectional pixel shifting member 150 shown in FIG. 26.

Here, a case in which light, which has a polarizing direction parallel to the shifting direction, is made incident on the sectional pixel shifting member is considered.

In the sectional pixel shifting member 150, which is illustrated in FIG. 26 or in FIG. 27 and which is structured as an optical element utilizing polarization of light, the first polarizing portion 150G is formed by a generally used beam displacer, and is structured so as to work to shift, one way in the scanning direction, the exiting direction of the extraordinary rays which are generated by light beams passing through this beam displacer. The beam displacer is structured such that the crystal optical axis is inclined 45° in the direction of shifting the beam, with respect to a normal line of the surface of incidence.

The third polarizing portion 150I shown in FIG. 27 is formed by a generally used beam displacer, and is structured so as to work to shift, the other way in the scanning direction, the exiting direction of the extraordinary rays which are generated by light beams passing through this beam displacer. Namely, the direction of polarizing the light beams at the first polarizing portion 150G and shifting the positions of the beam spots projected on the exposure surface, and the direction of polarizing the light beams at the third polarizing portion 150I and shifting the positions of the beam spots projected on the exposure surface, are opposite directions.

By changing and adjusting the respective thicknesses of the first polarizing portion 150G and the third polarizing portion 150I, the amounts of shifting of the positions of the beam spots which are projected onto the exposure surface of the photosensitive material 11 can be set to predetermined amounts.

Any of various methods can be thought of as the method for making the polarization directions of the light parallel to the shifting direction in structures using the sectional pixel shifting member 150 shown in FIG. 26 or FIG. 27. For example, a polarizing plate member 158 may be set before the light is incident on the sectional pixel shifting member 150.

The sectional pixel shifting member 150, which is structured as described above and which serves as the beam position converting section, divides the two-dimensional arrangement of the exposure beam spots into a first block, which passes through the one first polarizing portion 150G, and a second block, which passes through the other second transmitting portion 150H or third polarizing portion 150I, and sets the gap between the first block and the second block to the needed gap. Namely, at this beam position converting section, the two-dimensional arrangement of the exposure beam spots is divided into the first block and the second block, and the blocks are shifted with respect to one another, and the feed addressability (the position addressability) can be improved two times.

Although not illustrated, the sectional pixel shifting member may be structured so as to be divided into a combination of three blocks with the second transmitting portion 150H disposed between the first polarizing portion 150G and the third polarizing portion 150I, and the blocks shifted with respect to one another.

Structures, operations, and effects of the present fourth embodiment which are other than those described above, are similar to those of the above-described first and second embodiments, and therefore, description thereof will be omitted.

In the above embodiments, description is given of cases in which the two-dimensional arrangement of the exposure beam spots is divided into two blocks. However, the present invention is not limited to the same, and may be structured so as to divide into three or more blocks. In the case of a structure of dividing the two-dimensional arrangement of the exposure beam spots into three or more blocks in this way, higher feed addressability can be obtained while a high-speed scanning speed is maintained.

Further, the multibeam exposure device of the present invention may be structured such that the feed addressability (position addressability) is improved plural times, by dividing the two-dimensional arrangement of the exposure beam spots on the surface of the photosensitive material 11 which serves as the exposure surface, into plural blocks, and relatively shifting the positions among these plural blocks (i.e., by setting the gaps among the plural blocks to needed gaps).

The means structured to improve the feed addressability position addressability) of the multibeam exposure device plural times may be structured, for example, by a projecting section which is disposed between the DMD 36 and the photosensitive material 11 in the exposure head 26 illustrated in FIG. 6.

Further, the means structured to improve the feed addressability (position addressability) of the multibeam exposure device plural times may be structured, for example, by an optical device (including a light source, a DMD, and the like) which is disposed on the optical path from the light source to the photosensitive material 11 in the exposure head 26 illustrated in FIG. 6.

In the means structured to improve the feed addressability (position addressability) of the multibeam exposure device plural times, for example, in addition to the above-described beam position converting section, a means can be used which is structured so as to dividedly drive regions of a spatial light modulator used in beam control, and offset the driving timings among the respective divisional portions. In this way, the feed addressability (position addressability) of the multibeam exposure device can be improved even more.

As the means structured to improve the feed addressability (position addressability) of the multibeam exposure device plural times, it is possible to use, for example, a means which divides the DMD into a plurality of main blocks, and drives the DMDs while offsetting the timings per main block, and divides each main block into plural sub-blocks by the feed addressability improving device described in the above embodiments, and optically shifts the image drawing positions per sub-block.

For example, the means for changing the reset timings of the DMD at each block, which is disclosed in Japanese Patent Application No. 2004-205415, can be used as the means for dividing and driving the main blocks. The specification of Japanese Patent Application No. 2004-205415, and in particular, the disclosure of paragraphs 0073 through 0076 and FIGS. 8 and 9 of the drawings appended thereto, are incorporated by reference into the present specification as description of an embodiment relating to this means.

Further, for example, providing a data transfer device for each block and using a means for changing the driving timings of the respective blocks, which is disclosed in Japanese Patent Application No. 2004-302283, can be used as the device for dividing and driving the main blocks. The specification of Japanese Patent Application No. 2004-302283, and in particular, the disclosure of paragraphs 0062 through 0084 and FIGS. 8 through 12 of the drawings appended thereto, are incorporated by reference into the present specification as description of an embodiment relating to this means.

As described above, the number of main blocks can be reduced by also using a feed addressability improving device which uses an optical member. Therefore, the structure of the driving circuit of the DMD can be simplified.

Moreover, sub-blocks, which work so as to statically shift the image drawing positions by using an optical member, and main blocks, which can dynamically control the driving timings, may be combined. In this way, various types of dot arrangement patterns (dot arrangements on the image-drawing surface) can be realized while the number of main blocks is reduced. Therefore, even when, for example, the conveying speed of the stage is changed, the dot arrangement pattern can be controlled by adapting to circumstances, in order to realize the desired addressability.

Note that the multibeam exposure device of the present invention is not limited to the above-described embodiments, and can of course assume any of various other structures within a scope which does not deviate from the gist of the present invention.

In the multibeam exposure device of the present invention, the feed addressability improving device may be structured by a microlens array.

In the multibeam exposure device of the present invention, the feed addressability improving device may have at least one microaperture array provided with opening apertures which are formed so as to respectively correspond to the microlenses of a microlens array.

In accordance with such a structure the structure of the feed addressability improving device can be simplified, and the multibeam exposure device can be structured inexpensively.

In the multibeam exposure device of the present invention, the exposure surface of the multibeam exposure device may be disposed at the focal point position of the microlens array.

In accordance with such a structure, in addition to the operations and effects of the invention disclosed in any of claims 3 through 5, exposure of an even higher resolution can be carried out.

In the multibeam exposure device of the present invention, the feed addressability improving device may be structured by a beam position converting section which is disposed on optical paths of a plurality of exposure beams projected onto an exposure surface from a section which selectively turns a plurality of pixels on/off, and which is structured so as to tilt parallel flat plates, which correspond respectively to a plurality of blocks divided with respect to a feeding direction, such that relative positions between the blocks are shifted by a predetermined amount.

In the multibeam exposure device of the present invention, a section which selectively turns a plurality of pixels on/off may be a spatial light modulator, in which are arranged a plurality of light modulating elements whose light modulating states are individually controlled in accordance with control signals, the spatial light modulator able to selectively turn the plurality of pixels on/off by controlling the light modulating states of the respective light modulating elements.

In the multibeam exposure device of the present invention, the spatial light modulator may be a two-dimensional spatial light modulator in which light modulating elements are lined-up in two-dimensions, and the two-dimensional spatial light modulator may be disposed so as to tilt, with respect to a main scanning direction, a direction in which the light modulating elements are lined-up.

In accordance with the multibeam exposure method and device relating to the present invention, the positions of plural exposure beam spots, which are projected onto an exposure surface from an exposure head which is provided with a section for selectively turning a plurality of pixels on/off or the like, are divided into plural blocks on the exposure surface with respect to the feeding direction. The relative positions between these blocks are shifted by a predetermined amount, such that the gaps, in the feeding direction, at the positions of the plural exposure beam spots exposed at one block, are exposed by the plural exposure beam spots at another block. In this way, there is the effect that, without lowering the relative feeding speed between the exposure head and the photosensitive material or the like, the feed addressability can be improved and highly accurate exposure processing can be carried out.

1. A multibeam exposure device comprising:
an on/off element selectively turning on and off a plurality of pixels which are lined up in a scanning direction;
a feed addressability improving element dividing positions, on an exposure surface, of a plurality of exposure beam spots which are projected onto the exposure surface from the on/off element, into a plurality of blocks in a feeding direction, and shifting relative positions between the blocks by a predetermined amount; and
a control element controlling the on/off element such that all of the pixels are synchronized.

2. The device of claim 1, wherein the feed addressability improving element includes a microlens array.

3. The device of claim 2, wherein the feed addressability improving element includes at least one microaperture array in which are provided opening diaphragms which are formed so as to correspond respectively to microlenses of the microlens array.

4. The device of claim 2, wherein the exposure surface is disposed at a focal point position of the microlens array.

5. The device of claim 1, wherein the feed addressability improving element includes a beam position converting element disposed on an optical path of a plurality of exposure beams which are projected onto the exposure surface from the on/off element, the beam position converting element tilting flat plates, which correspond to the respective blocks, and shifting the relative positions between the blocks by the predetermined amount.

6. The device of claim 1, wherein the on/off element includes a spatial light modulator at which are disposed a plurality of light modulating elements whose light-modulating states are individually controlled in accordance with control signals, and the plurality of pixels can be selectively turned on and off by controlling the light-modulating states of the respective light modulating elements.

7. The device of claim 6, wherein the spatial light modulator is a two-dimensional spatial light modulator in which the light modulating elements are lined-up two-dimensionally, the two-dimensional spatial light modulator being disposed so as to tilt, with respect to the scanning direction, a direction in which the light modulating elements are lined-up.

8. A multibeam exposure device having an on/off element selectively turning on and off a plurality of pixels which are lined up in a scanning direction,
wherein the on/off element is structured so as to divide the pixels, which the on/off element selectively turns on and off, into a plurality of blocks in a feeding direction and to shift relative positions between the blocks by a predetermined amount, and a control element controls the on/off element such that all of the pixels are synchronized.

9. A multibeam exposure method comprising:
dividing, into a plurality of blocks in a feeding direction, positions, on an exposure surface, of a plurality of exposure beam spots which are projected onto the exposure surface from an on/off element which selectively turns on and off a plurality of pixels which are lined up in a scanning direction;
shifting relative positions between the blocks by a predetermined amount; and
carrying out scan-exposure with all of the pixels synchronized.

10. A multibeam exposure method comprising:
dividing, into a plurality of blocks in a feeding direction, positions, on an exposure surface, of a plurality of exposure beam spots which are projected onto the exposure surface by an intermediate image forming section corresponding to an on/off element which selectively turns on and off a plurality of pixels which are lined up in a scanning direction;
shifting relative positions between the blocks by a predetermined amount; and
carrying out scan-exposure with all of the pixels synchronized.

11. A method of exposing multibeams by a section which selectively turns on/off a plurality of pixels which are lined-up in a scanning direction, the method comprising:
dividing, into a plurality of blocks and with respect to a feeding direction, positions, on an exposure surface, of a plurality of exposure beam spots which are projected onto the exposure surface from the section which selectively turns on/off the plurality of pixels, and shifting relative positions between the blocks by a predetermined amount, and carrying out scan-exposure.

12. A method of exposing multibeams by an optical system comprising an intermediate image forming section which corresponds to a section which selectively turns on/off a plurality of pixels which are lined-up in a scanning direction, the method comprising:
dividing, into a plurality of blocks and with respect to a feeding direction, positions, on an exposure surface, of a plurality of exposure beam spots which are projected onto the exposure surface by the intermediate image forming section, and shifting relative positions between the blocks by a predetermined amount, and carrying out scan-exposure.

13. A multibeam exposure device comprising a section which selectively turns on/off a plurality of pixels which are lined-up in a scanning direction, the device comprising:
a feed addressability improving device which divides, into a plurality of blocks with respect to a feeding direction, positions, on an exposure surface, of a plurality of exposure beam spots which are projected onto the exposure surface from the section which selectively turns on/off the plurality of pixels, and shifts relative positions between the blocks by a predetermined amount.

14. A multibeam exposure device comprising a section which selectively turns on/off a plurality of pixels which are lined-up in a scanning direction, wherein:
the section which selectively turns on/off the plurality of pixels divides the pixels, which are selectively turned on/off, into a plurality of blocks, and shifts relative positions between the blocks by a predetermined amount.

15. A multibeam exposure device comprising a section which selectively turns on/off a plurality of pixels, and a projecting section, wherein:
a two-dimensional arrangement of exposure beam spots on an exposure surface is divided into a plurality of blocks by the projecting section which is disposed on an optical path from the section which selectively turns on/off the plurality of pixels to the exposure surface, and feed addressability is improved by relatively shifting positions between the plurality of blocks.

16. A multibeam exposure device comprising a section which selectively turns on/off a plurality of pixels, wherein:
a two-dimensional arrangement of exposure beam spots on an exposure surface is divided into a plurality of blocks by an optical device which is disposed on an optical path from a light source to the exposure surface, and feed addressability is improved by relatively shifting positions between the plurality of blocks.
